(19) United States
(12) Patent Application Publication
(10) Pub. No.: US 2004/0150618 A1
(43) Pub. Date: Aug. 5, 2004

(54) Display apparatus having auto-detecting device

(76) Inventor: Shin-Pin Huang, Taipei (TW)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/760,939

(22) Filed: Jan. 20, 2004

(30) Foreign Application Priority Data
Jan. 21, 2003 (TW) 092201107

(51) Int. Cl. G09G 5/00

(52) U.S. Cl. 345/156

(57) ABSTRACT

A display apparatus having an auto-detecting device is provided. The display apparatus includes: a display, a control circuit electrically connected to the display for controlling a display status of the display through an electrical connection thereof, an auto-detecting circuit electrically connected to the control circuit, and an auto-detector electrically connected to the auto-detecting circuit for detecting a living object in front of the display, thereby transmitting a detected result to the control circuit through the auto-detecting circuit so that the electrical connection of the control circuit is controlled according to the detecting result in order to control the display status of the display.

### FIELD OF THE INVENTION

The present invention is related to a display apparatus, and more particularly, to a display apparatus having an auto-detecting device.

### BACKGROUND OF THE INVENTION

Nowadays, computers have become necessary equipments for individuals in daily life. And, a computer includes a display apparatus for displaying the data and information. Generally, when a display apparatus displays the same image for a long time, the unaltered image will somehow harm the display apparatus itself. After a period of time, not only the display apparatus is damaged, but also the lifespan of the display apparatus is shortened. In order to prolong the lifespan of the display apparatus, the program of screen saver is designed. The screen saver will be automatically turned on when the computer is not being operated for a period of time and then display some pictures or animations to protect the display apparatus from being damaged.

However, the design of screen saver is to protect the display apparatus, not save the energy. Despite that partial software and screen savers include the mode of energy saving which allows the user to set up the automatically-turning-off period, this design does not always meet the user's requirements. That is, the set automatically-turning-off period is not always suitable for different kinds of jobs. For example, when the user looks at the computer and ponders his work, he would need a longer automatically-turning-off period before using the computer again. On the other hand, when the user often leaves his seat for a while, he would need a shorter automatically-turning-off period. In other words, every time the user needs a different length of automatically-turning-off period, he would have to set up the screen saver again, which is very inconvenient and impractical.

In addition, although some screen savers can be downloaded from the internet for free, or come with the purchase computer software, it is undeniable that many of the free screen savers have expired dates and some screen savers indeed cost money. Even if the cost is not high, it is an extra spending for the user. Furthermore, the user often sets a code for the screen saver in order to protect his own privacy and prevent somebody else from reading and using the information in the computer. In other words, the user has to key in the correct code to turn off the screen saver and turn on the display apparatus again after he is back to his seat, which takes time. Besides, when the screen saver or the energy saving software is turned on, not only the display apparatus is turned off, but also the computer system is paused temporarily. Therefore, it needs a period of time for the computer system to response and “re-activate” after the code for the screen saver is keyed in. Furthermore, since the screen saver is computer program which unavoidably takes some space in the hard drive, the available space in the hard drive will be less.

In addition, since the multi-media are very popular right now, the display apparatus is often used for displaying the images, such as TV images, VCD (Video compact disc) images, and DVD (Digital video disc). However, the display apparatuses of these VCD and DVD usually do not have screen savers or energy-saving devices. When the multi-media starts showing on the screen, the display apparatus is at a turning-on status, even there is no people staying in front of the display apparatus. In such a way, not only the energy is unnecessarily consumed, but also the lifespan of the display apparatus is shortened.

From the above description, it is known that how to design a display apparatus which saves the energy and is convenient for the user at the same time has become a major problem waited to be solved. In order to overcome the drawbacks in the prior art, a display apparatus having an auto-detecting device is provided. The particular design in the present invention not only solves the problem that the display apparatus is continuously turned on even the user is not there, but also solves the inconvenience of waiting the computer system to be “awake” after keying in the code for the screen saver. Thus, the invention has the utility for the industry.

### SUMMARY OF THE INVENTION

The main purpose of the present invention is to provide a display apparatus having an auto-detecting device, which automatically detects whether there is a human body in front of the display, and then turns on or turns off the display.

It is one object of the present invention to provide a display apparatus having an auto-detecting device, which automatically turns on or turns off the display for achieving the purpose of energy saving.

It is another object of the present invention to provide a display apparatus having an auto-detecting device, which automatically turns on or turns off the display without the need of the screen saver so that it is more convenient and saves the user's time.

According to one aspect of the present invention, a display apparatus having an auto-detecting device, includes: a display, a control circuit electrically connected to the display for controlling a display status of the display through an electrical connection thereof, an auto-detecting circuit electrically connected to the control circuit, and an auto-detector electrically connected to the auto-detecting circuit for detecting a living object in front of the display, thereby transmitting a detected result to the control circuit through the auto-detecting circuit so that the electrical connection of the control circuit is controlled according to the detected result in order to control the display status of the display.

In accordance with the present invention, the display further comprises a display panel.

Preferably, the auto-detector is fixedly mounted on the display panel.

Preferably, the display apparatus further includes a mobile rack disposed near the display.

Preferably, the auto-detector is mounted on the mobile rack for detecting the human body in front of the mobile rack.

Preferably, the display apparatus further includes a power source connected with the control circuit for providing a power for the display.

Preferably, the power source is plugged in a socket for providing the power for the display through a rectifier.

Preferably, the electrical connection of the control circuit is switched into a connected state in response to the detected result so as to turn on the display when the auto-detector detects the living object.

Preferably, the electrical connection of the control circuit is switched into a disconnected state in response to the detected result so as to turn off the display when the auto-detector detects no living object in front of the display.

Preferably, the auto-detector is an infrared sensor.

Preferably, the auto-detector is a radio frequency (RF) transmitting sensor.

Preferably, the display is one of a cathode ray tube (CRT) monitor and a liquid crystal display (LCD).

Preferably, the living object is a human body.

Preferably, the display is one selected from a group consisting of a plasma display, a rear projection display, and an organic light emitting display (OLED).

According to another aspect of the present invention, a display apparatus having an auto-detecting device includes: a display, a control circuit electrically connected to the display for controlling a display status of the display through an electrical connection thereof, and an auto-detecting device electrically connected to the control circuit for detecting a living object in front of the display, thereby transmitting a detected result to the control circuit so that the electrical connection of the control circuit is controlled according to the detected result in order to control the display status of the display.

According to another aspect of the present invention, a display apparatus having an auto-detecting device includes: a display, and an auto-detecting device electrically connected to the display for detecting a human body in front of the display and controlling a display status of the display according to a detected result.

The foregoing and other features and advantages of the present invention will be more clearly understood through the following descriptions with reference to the drawings, wherein:

### BRIEF DESCRIPTION OF THE DRAWINGS

FIG. 1 is a block diagram illustrating the display apparatus having an auto-detecting device according to a preferred embodiment of the present invention;

FIG. 2 is a diagram illustrating the outside appearance of the display apparatus having an auto-detecting device according to a preferred embodiment of the present invention;

FIG. 3 is a diagram illustrating the working place using the display apparatus having an auto-detecting device according to a preferred embodiment of the present invention; and

FIG. 4 is a diagram illustrating the outside appearance of the display apparatus having an auto-detecting device according to another preferred embodiment of the present invention.

### DETAILED DESCRIPTION OF THE PREFERRED EMBODIMENT

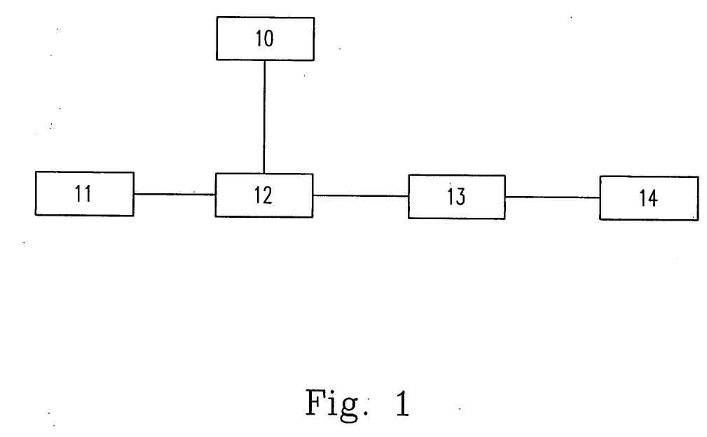

The present invention will now be described more specifically with reference to the following embodiments. Please refer to FIG. 1. FIG. 1 is a block diagram illustrating the display apparatus having an auto-detecting device according to a preferred embodiment of the present invention. The display apparatus provided in the present invention includes the display 11, the power source 10, the control circuit 12, the auto-detecting circuit 13, and the auto-detector 14. The control circuit 12 is electrically connected to the display 11 for controlling the display status of the display 11 through an electrical connection thereof. The power source 10 is connected with the control circuit 12 for providing power for the display 11. The auto-detecting circuit 13 is electrically connected to the control circuit 12. Further, the auto-detector 14 is electrically connected to the auto-detecting circuit 13 for detecting a living object in front of the display 11. Preferably, the living object is human body. After detecting, the detected result is transmitted to the control circuit 12 through the auto-detecting circuit 13. Then, the electrical connection of the control circuit 12 is controlled according to the detected result in order to control the display status of the display 11. Preferably, the power source 10 is plugged in a socket (not shown) for providing power for the display 11 through a rectifier (not shown). Since the application principle for the power source 10 is as same as the prior art, it is not described repeatedly here.

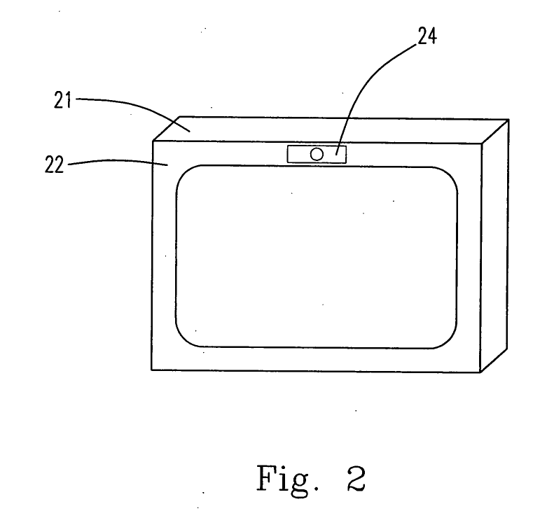

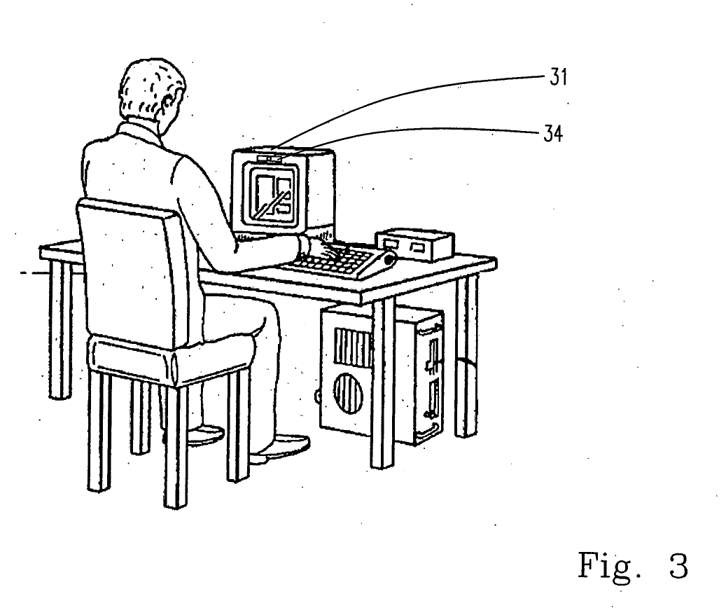

The characteristic of the present invention is that the display 11 includes the auto-detector 14 mounted thereon for detecting whether there is human body in front of the display 11 so that the display 11 can be automatically turned on or turned off. Please refer to FIG. 2. FIG. 2 is a diagram illustrating the outside appearance of the display apparatus having an auto-detecting device according to a preferred embodiment of the present invention. According to a preferred embodiment in the present invention, the display 21 further includes the display panel 22. The auto-detector 24 is fixedly mounted on the display panel 22. Please refer to FIG. 3. FIG. 3 is a diagram illustrating the working place using the display apparatus having an auto-detecting device according to a preferred embodiment of the present invention. When the auto-detector 34 detects the human body in front of the display 31, the detected result is transmitted to the control circuit 12 through the auto-detecting circuit 13. The electrical connection of the control circuit 12 is then switched into connected state in response to the detected result so as to turn on the display 31 when the auto-detector 34 detects human body. On the contrary, when the auto-detector 34 detects no human body in front of the display 31, the detected result is transmitted to the control circuit 12 through the auto-detecting circuit 13. The electrical connection of the control circuit 12 is then switched into disconnected state in response to the detected result so as to turn off the display 31 when the auto-detector 34 detects no human body in front of the display 31.

In other words, when the user sits in front of the display apparatus, the display 31 will be tuned on automatically. When the user leaves his seat, the display 31 will be turned off automatically. That is, the user does not have to turn off the power source of the display 31 to achieve the purpose of energy saving. Besides, since the display 31 is turned off automatically after the user leaves the seat, the information shown on the screen will not easily be seen by other people, thereby it helps the protection of the user's privacy. When the user gets back to his seat, the display 31 will be turned on automatically without the need of keying in the code for the screen saver, which saves the user's time and is very convenient for the user. The user won't have to spend extra money to buy the screen saver either. Furthermore, since the display 31 is controlled by the electrical connection of control circuit 12, the computer system is still under operating mode, unlike the computer system temporarily paused by the screen saver or energy-saving program. The responding time of the auto-detector 14 in the present invention is much shorter than that of the screen saver. Therefore, the user does not have to spend time waiting the turning-off of the screen saver and the computer to be “awake.”

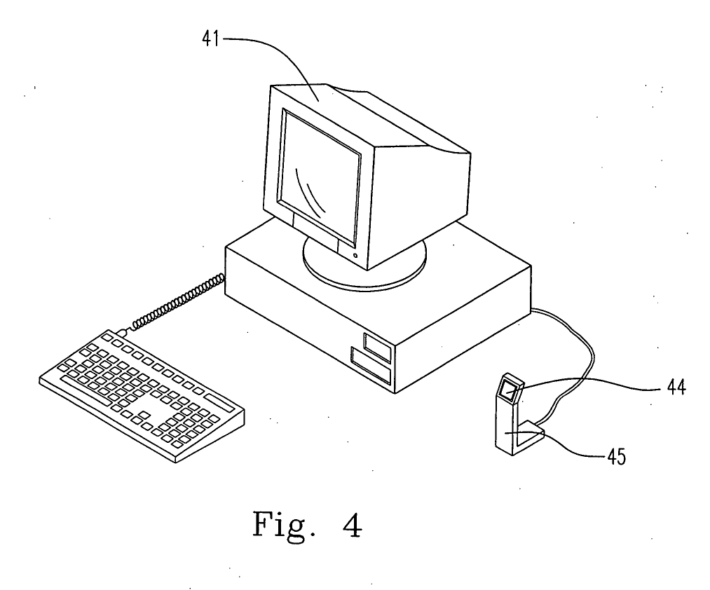

Please refer to FIG. 4. FIG. 4 is a diagram illustrating the outside appearance of the display apparatus having an auto-detecting device according to another preferred embodiment of the present invention. The display 41 further includes the mobile rack 45 disposed near the display 41. The auto-detector 44 is mounted on the mobile rack 45 for detecting the human body in front of the mobile rack 45. Since the mobile rack 45 can be moved near the display 41, the auto-detector 44 can detect human body at any side, not only the front side of the display 41. In other words, the user does not have to be in front of the display 41. The user can freely adjust the position of the mobile rack 45 and the detecting direction of the auto-detector 44 based on his sitting position. In addition, according to the above preferred embodiments in the present invention, the auto-detector can be infrared sensor or radio frequency (RF) transmitting sensor. The display can be cathode ray tube (CRT) monitor or liquid crystal display (LCD). The display is can be plasma display, rear projection display, or organic light emitting display (OLED).

According to the above, the drawbacks in the conventional display apparatus are not existed in the display apparatus provided in the present invention. The display apparatus can be automatically turned on or turned off according to the detected result of the auto-detector that whether there is human body in front of the display. Therefore, the energy-saving program or screen save is no longer required in the computer system and the purpose of energy-saving is achieved at the same time. Moreover, since the auto-detector of the display apparatus provided in the present invention has the feature of shorter responding time, the user doe not have to wait for a long time before the computer system responds. Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display apparatus having an auto-detecting device, comprising:
a display;
a control circuit electrically connected to said display for controlling a display status of said display through an electrical connection thereof;
an auto-detecting circuit electrically connected to said control circuit; and
an auto-detector electrically connected to said auto-detecting circuit for detecting a living object in front of said display, thereby transmitting a detected result to said control circuit through said auto-detecting circuit so that said electrical connection of said control circuit is controlled according to said detected result in order to control said display status of said display.

2. The display apparatus according to claim 1, when said display further comprises a display panel.

3. The display apparatus according to claim 2, wherein said auto-detector is fixedly mounted on said display panel.

4. The display apparatus according to claim 1 further comprising a mobile rack disposed near said display.

5. The display apparatus according to claim 4, wherein said auto-detector is mounted on said mobile rack for detecting said human body in front of said mobile rack.

6. The display apparatus according to claim 1 further comprising a power source connected with said control circuit for providing a power for said display.

7. The display apparatus according to claim 6, wherein said power source is plugged in a socket for providing said power for said display through a rectifier.

8. The display apparatus according to claim 1, wherein said electrical connection of said control circuit is switched into a connected state in response to said detected result so as to turn on said display when said auto-detector detects said living object.

9. The display apparatus according to claim 1, wherein said electrical connection of said control circuit is switched into a disconnected state in response to said detected result so as to turn off said display when said auto-detector detects no living object in front of said display.

10. The display apparatus according to claim 1, wherein said auto-detector is an infrared sensor.

11. The display apparatus according to claim 1, wherein said auto-detector is a radio frequency (RF) transmitting sensor.

12. The display apparatus according to claim 1, wherein said display is one of a cathode ray tube (CRT) monitor and a liquid crystal display (LCD).

13. The display apparatus according to claim 1, wherein said living object is a human body.

14. The display apparatus according to claim 1, wherein said display is one selected from a group consisting of a plasma display, a rear projection display, and an organic light emitting display (OLED).

15. A display apparatus having an auto-detecting device, comprising:
a display;
a control circuit electrically connected to said display for controlling a display status of said display through an electrical connection thereof; and
an auto-detecting device electrically connected to said control circuit for detecting a living object in front of said display, thereby transmitting a detected result to said control circuit so that said electrical connection of said control circuit is controlled according to said detected result in order to control said display status of said display.

16. A display apparatus having an auto-detecting device, comprising:
a display; and
an auto-detecting device electrically connected to said display for detecting a human body in front of said display and controlling a display status of said display according to a detected result.
